(19) United States
(12) Patent Application Publication
(10) Pub. No.: US 2005/0102222 A1
(43) Pub. Date: May 12, 2005

(54) Obligation establishment supporting system, and a method and a computer program thereof

(75) Inventors: Kazuo Masuda, Tokyo (JP); Masayo Saegusa, Tokyo (JP)

Correspondence Address: DICKINSON WRIGHT PLLC, 1901 L. STREET NW, SUITE 800, WASHINGTON, DC, 20036, US

(73) Assignee: MITSUBISHI CORPORATION, Tokyo (JP)

(21) Appl. No.: 10/621,732

(22) Filed: Jul. 18, 2003

Related U.S. Application Data
(63) Continuation of application No. PCT/JP02/00308, filed on Jan. 18, 2002.

(30) Foreign Application Priority Data
Jan. 19, 2001 (JP) 2001-12469

(51) Int. Cl. G06F 17/60

(52) U.S. Cl. 705/38

(57) ABSTRACT

In order to extend the condition of the credit or debt for the transaction, a supporting system for establishing an obligation, includes a requirement obtaining unit for obtaining a condition of an obligation desired by a user who desires to acquire a credit, for example, an obligation information obtaining unit for obtaining a detailed condition including amount and a collection due date of the obligation and an obligation composing unit for generating a composed obligation according to the condition obtained by the requirement obtaining unit by combining a plurality of obligations based on the detailed condition obtained by the obligation information obtaining unit.

The present patent application is a continuation application of PCT application No. PCT/JP02/00308 filed on Jan. 18, 2002, which claims priority from a Japanese patent application No. 2001-12469 filed on Jan. 19, 2001, the contents of which are incorporated herein by reference.

### BACKGROUND OF THE INVENTION

1. Field of the Invention

The present invention relates to an obligation establishment supporting system, and a method and a computer program thereof, wherein it is possible to establish the obligations such as, for example, credits and debts, and expand the range of the establishment and trading thereof.

2. Description of the Related Art

When users establish an obligation such as, for example, credits or debts, or trading thereof, the user, who is to be the obligee or creditor, generally starts to establish an obligation or credit or trade one by one under the condition where the obligor or debtor has at least certain capacity for paying off his or her debt.

In the conventional method, the obligee or the obligor has requested a user, who desires to acquire an obligation like a credit, to buy an obligation individually. Therefore, the range of establishing the obligation has been limited as for the obligee or the obligor.

Moreover, the user, who desires to acquire a credit, has judged the capacity of the debtor for paying off his or her debt individually, whenever the user trade the credit. Hence, the range of establishing the obligation or the range of the trade was being limited.

For that reason, the range of establishing the obligation or the range of the transaction was being limited more or less.

### SUMMARY OF THE INVENTION

Therefore, it is an object of the present invention to provide a supporting system for establishing an obligation and a supporting method and a computer program thereof, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a supporting system for establishing an obligation, includes a requirement obtaining unit for obtaining a condition of an obligation desired by a user who desires to acquire a credit, for example, an obligation information obtaining unit for obtaining a detailed condition including amount and a collection due date of the obligation and an obligation composing unit for generating a composed obligation according to the condition obtained by the requirement obtaining unit by combining a plurality of obligations based on the detailed condition obtained by the obligation information obtaining unit.

The supporting system for establishing an obligation, may further include a rank storing unit for storing a rank indicating a collection risk of the debtor, wherein the obligation composing unit decides the obligation by using the rank stored in the rank storing unit.

The supporting system for establishing an obligation, may further include a composition condition database for storing a condition under which the plurality of obligations are composed, wherein the obligations composion unit generated the composed obligation by using the condition stored in the composition condition database.

The requirement obtaining unit may obtain a collection due date desired by the user who desires to acquire a credit, and the obligation composing unit may set the collection due date obtained by the requirement obtaining unit to be a collection due date of the composed obligation.

The supporting system for establishing an obligation, may further include an interest charge adding unit for calculating an interest charge created during a term from a collection due date of the obligation to the collection due date of the composed obligation, and adding the interest charge to money flow created by a transaction of the original obligation.

The obligation composing unit may divide the obligation, of which collection due date is later than a collection due date of the composed obligation, into a plurality of obligations by dividing a payment term of the obligation, and generate the composed obligation by using the divided obligations.

The obligation composing unit may divide the obligation into a plurality of obligations by dividing amount of the obligation and generate the composed obligation by using at least one of the divided obligations.

According to the second aspect of the present invention, a supporting system for establishing an obligation, comprises an obligation database for storing a condition of an obligation to be an object of selling or setting, a requirement obtaining unit for obtaining a condition of an obligation desired by users who desire to acquire a credit from terminals for the users, wherein the users includes several, different kinds of investors, an obligation information obtaining unit for obtaining information about the obligation according to the condition obtained by the requirement obtaining unit from the obligation database and a confirming unit for allowing the users to confirm the information obtained by the obligation information obtaining unit by sending the information to the terminals for the users.

According to the third aspect of the present invention, a supporting method for establishing an obligation, includes the steps of obtaining a condition of an obligation desired by a user who desires to acquire a credit, for example, obtaining a detailed condition including amount and collection due dates of the obligations, generating a composed obligation according to the obtained condition by combining the obligations based on the detailed condition and informing the user of the condition of the composed obligation.

According to the fourth aspect of the present invention, a supporting method for establishing an obligation, includes the steps of managing a condition an obligation to be an object of selling or setting, obtaining a condition of the obligation desired by users who desire to acquire a credit, wherein the users include several, different kinds of investors and selecting an obligation according to the obtained condition from the managed obligation and informing the users of the selected obligation.

According to the fifth aspect of the present invention, a supporting computer program for establishing an obligation, includes a requirement obtaining module for obtaining a condition of an obligation desired by a user who desires to acquire a credit, for example, a credit condition obtaining module for obtaining a detailed condition including amount and collection due dates of the obligations and a credit composing module for generating a composed obligation according to the condition obtained by the requirement obtaining module by combining a plurality of the obligations based on collection risk and the price of obligation.

According to the sixth aspect of the present invention, a supporting computer program for establishing an obligation, includes a requirement obtaining module for obtaining a condition of an obligation desired by users who desire to acquire a credit, for example, from terminals for the users, wherein the users include several, different kinds of investors, an obligation information obtaining module for obtaining information about the obligation according to the condition obtained by the requirement obtaining module from an obligation database storing a condition of the obligation to be an object of selling or setting and a confirming module for allowing the users to confirm the information obtained by the obligation information obtaining module by sending the information to the terminals for the users.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of a system including a supporting system for establishing an obligation 200, which is the first embodiment of the present invention.

FIG. 2 shows the configuration of the supporting system for establishing an obligation 200.

FIG. 3 shows an example of the obligation database 210.

FIG. 4 shows an example of the rank database 220.

FIG. 5 shows an example of the composition condition database 230.

FIG. 6 shows an example of the composed obligation database 240.

FIG. 7 shows an example of the display of the terminal for the user who desires to acquire an obligation 500.

FIG. 8 shows another example of the display of the displaying unit 510 of the terminal for the user who desires to acquire an obligation 500.

FIG. 9 shows an example of the displaying unit 401 or the displaying unit 421 of the obligor terminal 400 or the present obligee terminal 420.

FIG. 10 shows a flowchart indicating the process of the supporting system for establishing an obligation 200, the obligor terminal 400 and the terminal for the user who desires to acquire an obligation 500.

FIG. 11 shows the continued process shown in FIG. 10.

FIG. 12 and FIG. 13 are the flowcharts showing the detailed process of the step S160 shown in FIG. 10.

FIG. 14 is the flowchart showing the detailed process of the step S470 shown in FIG. 13.

FIG. 15 is the flowchart showing the detailed process of the step S520 shown in FIG. 13.

FIG. 16 is the block diagram showing the hardware configuration of the supporting system for establishing an obligation 200.

FIG. 17 shows an example of the supporting system for establishing an obligation 201.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

### 1. FIRST EMBODIMENT

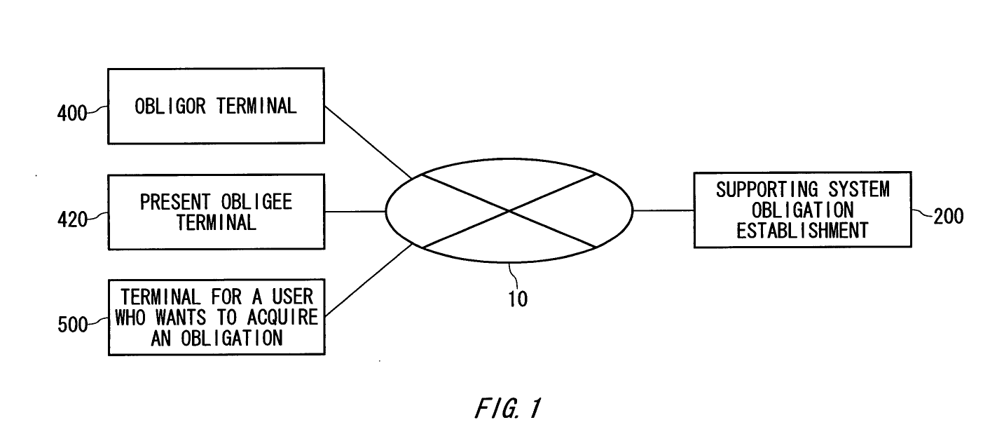

FIG. 1 shows an example of a system including a supporting system for establishing an obligation 200, which is the first embodiment of the present invention. In the present embodiment, the supporting system for establishing an obligation 200 is coupled to an obligor terminal 400, a present obligee terminal 420 and a terminal for the user who desires to acquire an obligation 500 through the Internet 10. The present obligee and the user who desires to acquire a credit may include several, different kinds of investors. The supporting system for establishing an obligation 200 receives the request of the obligor for establishing a credit such as a credit sale or a debt such as an acceptance of the debt from the obligor terminal 400 or the request of the present obligee for selling a credit or debt from the present obligee terminal 420. The supporting system for establishing an obligation 200 obtains the condition of the obligation, which the user who desires to acquire a credit desires, from the terminal for a user who desires to acquire an obligation 500, assembles the credits or the debts, namely, the original obligation, generates the composed obligation according to the obtained condition of the obligation and sends the condition of the composed obligation such as the amount or the collection due date to the terminal for the user who desires to acquire an obligation 500.

That is, the supporting system for establishing an obligation 200 is a system supporting the obligor and the present obligee to sell the credits or the debts, which they desire to be sold, to the user who desires to acquire a credit by assembling the credits or the debts.

Here, each of the obligor terminal 400, the present obligee terminal 420 and the terminal for the user who desires to acquire an obligation 500 may be more than one.

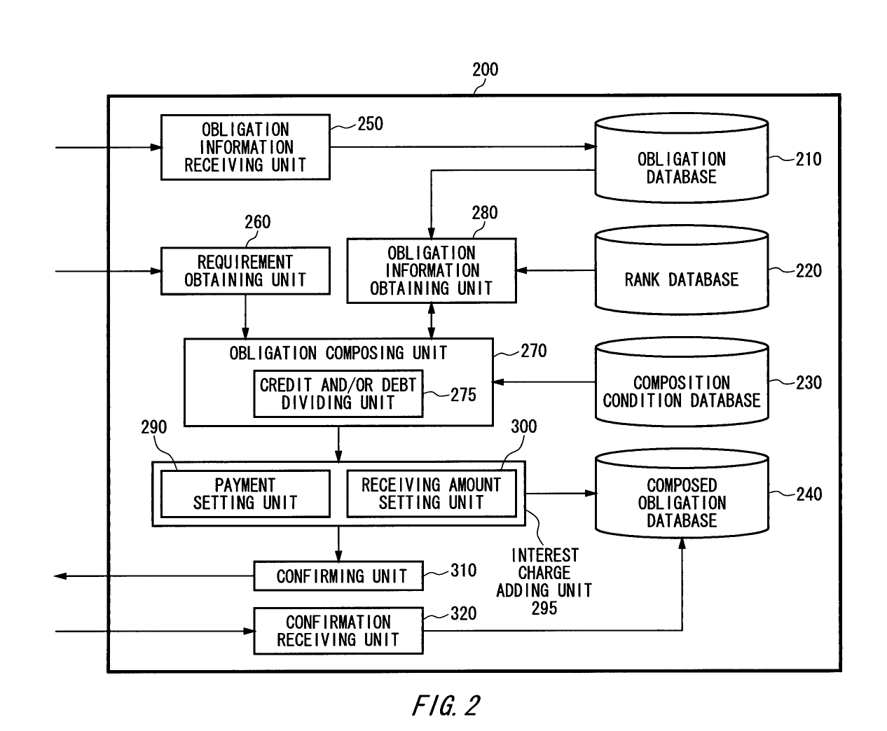

FIG. 2 shows the configuration of the supporting system for establishing an obligation 200. As databases, the supporting system for establishing an obligation 200 has an obligation database 210, a rank data base 220, a composition condition database 230 and a composed obligation database 240. Moreover, a soperating units, the supporting system for establishing the obligation 200 has an obligation information receiving unit 250, a requirement obtaining unit 260, a nobligation composing unit 270, a nobligation information obtaining unit 280, an interest charge adding unit 295, a confirming unit 310 and a confirmation receiving unit 320. The interest charge adding unit 295 has a payment setting unit 290 and a receiving amount setting unit 300.

The obligation database 210 stores the information about the obligation, for example, received from the obligor terminal 400 and the present obligee terminal 420 corresponding to the obligation ID.

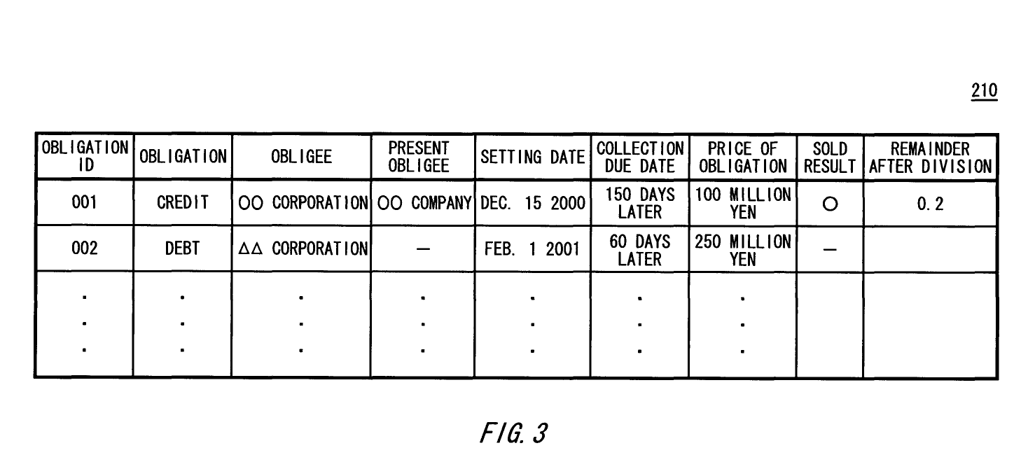

FIG. 3 shows an example of the obligation database 210. In the present embodiment, the obligation database 210 has a obligation ID field, a obligation field, a obligor field, a present obligee field, an establishment date field, a collection due date field, a price of obligation field, a sold result field, and a remainder after division field.

The obligation ID field stores the obligation ID, which is unique to the obligation such as the obligation. The obligation field stores the information by which the credit and the debt can be discriminated. The obligation field may further store the information by which the kind or type of the obligation is discriminated.

The obligor field stores the information by which the obligor of the obligation is specified. The information stored in the obligor field may by the name of the obligor itself or the unique ID of the obligor.

The present obligee field stores the information by which the present obligee having the obligation is specified. The information stored in the present obligee field may be the name of the present obligee itself or the unique ID of the present obligee. Moreover, if the obligation is not established, the information is not stored in the present obligee field.

The setting date field stores the date when the obligation is established. If the obligation is not established, the expected date when the obligation will be established is stored in the setting date field.

In the collection due date field, the information by which the date when the obligation is collected is specified is stored. The information stored in the collection due date field may be the information indicating the term from the setting date to the collection due date or the collection due date itself. In the price of obligation field, the information indicating the amount of the obligation is stored.

In the sold result field, the information indicating whether the obligation is sold or not is stored. For example, if a credit is sold as a part of the composed obligation, the information indicating “o” is stored in the field where the sale is finished.

In the remainder after division field, if the obligation is divided and sold, the information indicating the amount of the obligation remaining without being sold is stored. Owing to the remainder after division field, the supporting system for establishing an obligation 200 can use the obligation remaining from the division as the original obligation, which is the basis of the composed obligation.

The rank database 220 stores the information by which the obligor is specified and the rank indicating the collection risk of the obligor in order that both correspond to each other.

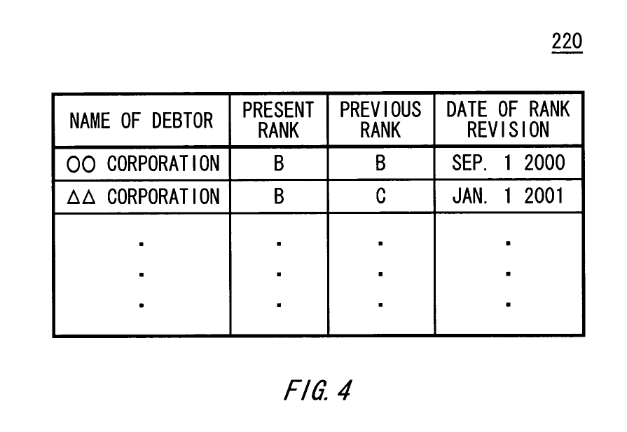

FIG. 4 shows an example of the rank database 220. In the present embodiment, the rank database 220 has a name of obligor field, a present rank field, a previous rank field and a date of rank revision field.

The name of obligor field stores the information by which the obligor is specified. The information by which the obligor is specified may by the name of the obligor itself or the unique ID of the obligor.

The present rank field stores the information indicating the present rank of the obligor. The previous rank field stores the previous rank of the obligor. The date of rank revision field stores the information by which the date of the rank division is specified. Owing to the present rank field and the previous rank field, the supporting system for establishing an obligation 200 can grasp the tendency of the collection risk of the obligor.

The composition condition database 230 stores the condition required for the original obligation, which is the basis of the composed obligation.

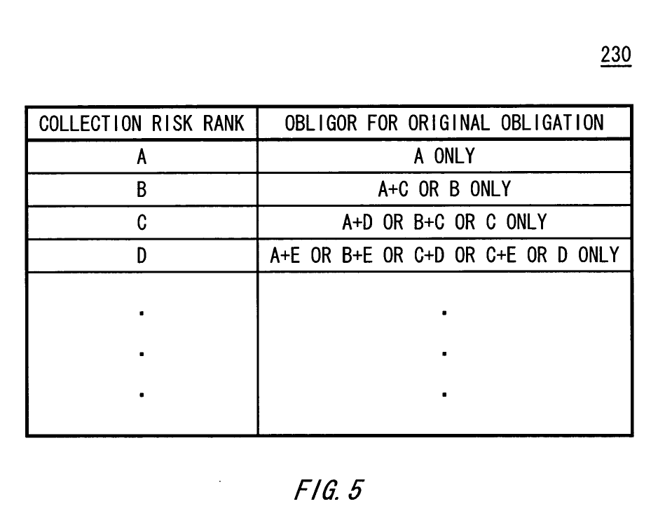

FIG. 5 shows an example of the composition condition database 230. In the present embodiment, the composition condition data base 230 has a collection risk rank field and a obligor condition field. The collection risk rank field stores the rank indicating the collection risk of the composed obligation. The obligor condition field stores the rank indicating the collection risk required for the obligor of the original obligation. More particularly, if the collection risk required for the composed obligation is A rank, the condition of the obligor of the original obligation is only A rank. Furthermore, if the collection risk required for the composed obligation is A rank, the condition of the obligor of the original obligation is the combination of A rank and C rank or only A rank.

That is, the supporting system for establishing an obligation 200 can generate the composed obligation efficiently by using the composition condition database 230.

The composed obligation database 240 stores various sets of information about the composed obligation for each composed obligation or debt.

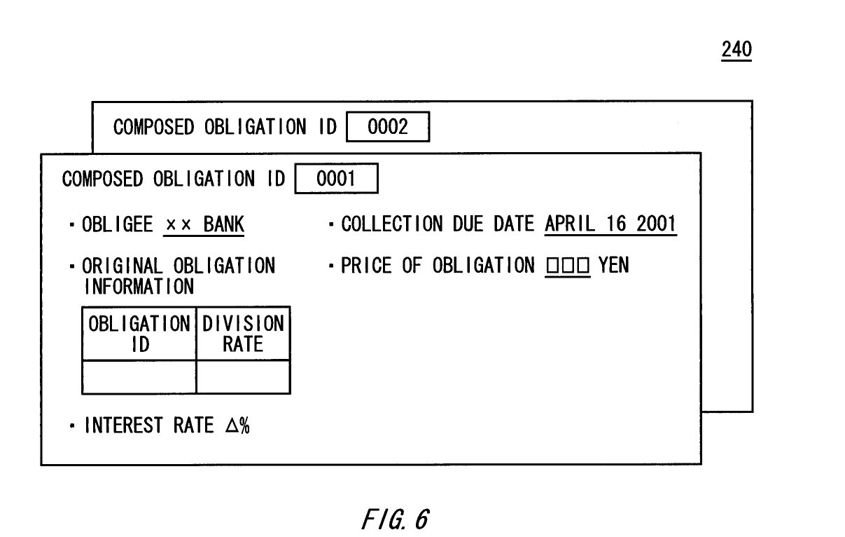

FIG. 6 shows an example of the composed obligation database 240. In the present embodiment, the composed obligation database 240 has tables for each composed obligation or debt. Each table has a composed obligation ID field, a obligee field, a collection due date field, an original obligation information field, an amount of obligation field and an interest rate field.

The composed obligation ID field stores the unique ID of the composed obligation. The obligee field stores the information by which the user who has bought the composed obligation, namely, the obligee is specified. The collection due date field stores the information by which the collection due date of the composed obligation is specified. The original obligation information field stores the credit debt ID by which the original obligation is specified and the division rate indicating how much the original obligation is used for the original obligation or credit of the composed obligation or credit. The amount of obligation field stores the price of obligation of the composed obligation. The interest rate field stores the interest rate or the interest charge of the composed obligation.

Returning to FIG. 2, the obligation information receiving unit 250 receives the detailed condition including the price of obligation of the obligation about the credit and the collection due date and the request for selling the credit from the obligor terminal 400 or the present obligee terminal 420. Then, the obligation information receiving unit 250 stores the received information about the credit in the obligation database 210. In the information received by the obligation information receiving unit 250, at least the information stored in the obligation database 210 is included.

The requirement obtaining unit 260 obtains the condition for the composed obligation, which the user who desires to acquire a credit, for example, desires to buy or establish, from the terminal for the user who desires to acquire an obligation 500, and sends it to the obligation composing unit 270. Here, in the information received by the requirement obtaining unit 260, the information by which whether the request is for the obligation is discriminated is included.

When the obligation composing unit 270 receives the condition for the composed obligation from the requirement obtaining unit 260, it retrieves the composition condition according to the condition for the obligation from the composition condition database 230 and sends the retrieved composition condition to the obligation information obtaining unit 280. Moreover, as the response to the composition condition, the obligation composing unit 270 obtains the detailed condition including the price of obligation of the obligation about the original obligation, which is the basis of the composed obligation, from the obligation information obtaining unit 280, and generates the composed obligation by using the obtained detailed condition. Furthermore, the obligation composing unit 270 sends the information about the composed obligation to the payment setting unit 290 and the receiving amount setting unit 300.

Moreover, the obligation composing unit 270 has an obligation dividing unit 275. The obligation dividing unit 275 divides the obligation sent by the obligation information obtaining unit 280 into a plurality of credits or debts by dividing the term of the obligation into a plurality of terms, if the collection due date included in the condition obtained by the requirement obtaining unit 260 is different from that of the obligation sent by the obligation information obtaining unit 280.

Moreover, the obligation dividing unit 275 divides the obligation sent by the obligation information obtaining unit 280 into a plurality of obligations based on the price, if the condition obtained by requirement obtaining unit 260 does not match the obligation sent by the obligation information obtaining unit 280.

In this case, the obligation composing unit 270 uses the divided credit or debt as the original obligation.

The obligation information obtaining unit 280 chooses the original obligation, which is the basis of the composed obligation, in the obligation database 210 according to the condition sent by the obligation composing unit 270, and retrieves the information of the original obligation, which is chosen, from the obligation database 210. At this time, the obligation information obtaining unit 280 obtains the collection rank of the obligor stored in the obligation database 210 by using the rank database 220, and selects the original obligation in the obligation database 210 by using the obtained collection rank.

The interest charge adding unit 295 calculates the interest charge, which occurs from the collection due date of the obligation to the collection due date of the composed obligation, adds the interest charge to the money created by the set-up or the transaction of the obligation, for example, the amount of payment, which the user who desires to acquire a credit should pay, or the amount of receipt, which the obligor or the original obligee should receive. The detailed operation of the interest charge adding unit 295 is achieved by the payment setting unit 290 and the receiving amount setting unit 300.

The payment setting unit 290 sets the amount of payment, which the user who desires to acquire a credit should pay, by using the information about the composed obligation sent by the obligation composing unit 270.

More particularly, if the obligation composing unit 270 sets the last collection due date for the original obligation, which is the basis of the composition, to be the collection due date of the composed obligation, the payment setting unit 290 sets the amount of the payment by adding a predetermined charge, which the administrator of the supporting system for establishing an obligation 200 should receive, and the interest charge, which is created from the collection due date of the original obligation to the collection due date of the composed obligation, to the sum of the original obligation. Moreover, if the obligation composing unit 270 sets the collection due date obtained by the requirement obtaining unit 260 to be the collection due date of the composed obligation, the payment setting unit 290, for example, sets the amount of the payment by adding a predetermined charge, which the administrator of the supporting system for establishing an obligation 200 should receive, and the interest charge, which is created from the collection due date of the original obligation to the collection due date of the composed obligation, to the sum of the original obligation. Furthermore, if the due date of payment of the composed obligation is the same as those of each of the original obligations, the payment setting unit 290 sets the amount of the payment by adding a predetermined charge, which the administrator of the supporting system for establishing an obligation 200 should receive, to the sum of the original obligation.

The receiving amount setting unit 300 sets the amount of the receipt, which the obligor or the original obligee should receive, by using the information about the composed obligation sent by the obligation composing unit 270.

More particularly, if the obligation composing unit 270 sets the last collection due date for the original obligation, which is the basis of the composition, to be the collection due date of the composed obligation, the receiving amount setting unit 300, for example, sets the amount of the payment by deducting a predetermined charge, which the administrator of the supporting system for establishing an obligation 200 should receive, and the interest charge, which is created from the collection due date of the original obligation to the collection due date of the composed obligation, from the sum of the original obligation. Moreover, if the obligation composing unit 270 sets the collection due date obtained by the requirement obtaining unit 260 to be the collection due date of the composed obligation, the receiving amount setting unit 300, for example, sets the amount of the receipt by deducting a predetermined charge, which the administrator of the supporting system for establishing an obligation 200 should receive, and the interest charge, which is created from the collection due date of the original obligation to the collection due date of the composed obligation, from the sum of the original obligation. Furthermore, if the due date of payment of the composed obligation is the same as those of each of the original obligations, the receiving amount setting unit 300 sets the amount of the receipt by deducting a predetermined charge, which the administrator of the supporting system for establishing an obligation 200 should receive, from the sum of the original obligation.

Here, one of the payment setting unit 290 and the receiving amount setting unit 300, according to the information of the composed obligation sent by the obligation composing unit 270, sets the amount of the payment or receipt considering the interest charge created from the collection due date of the original obligation to the collection due date of the composed obligation. Moreover, the payment setting unit 290 and the receiving amount setting unit 300 send the information about the composed obligation including the amount of the payment or receipt and the information about the customers to the confirming unit 310.

When the confirming unit 310 receives the information about the composed obligation and the information about the customers, it sends the information about the composed obligation including the amount of the payment to the terminal for the user who desires to acquire an obligation 500, while sending the information about the composed obligation including the amount of the receipt to the obligor terminal 400 or the present obligee terminal 420.

If the confirmation receiving unit 320 receives the information indicating the acceptance of selling the obligation from the obligor terminal 400 or the present obligee terminal 420 and the information indicating the acceptance of buying the composed obligation from the terminal for the user who desires to acquire an obligation 500, it stores the information about the composed obligation, which is set, in the composed obligation database 240.

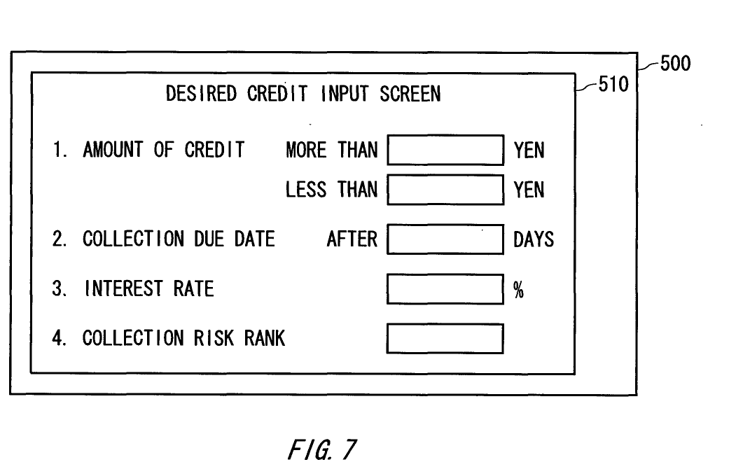

FIG. 7 shows an example of the display of the terminal for the user who desires to acquire an obligation 500. The example is a screen in which the user who desires to acquire a credit inputs the desired condition for the credit to be acquired. In the present example, the displaying unit 510 displays a blank in which the amount of the credit is inputted, a blank in which the collection due date is inputted, a blank in which the interest rate is inputted and a blank in which the collection risk rank.

The screen of in which the user who desires to acquire a debt inputs the desired condition for the debt to be acquired will not be described, because it is substantially similar to the example above.

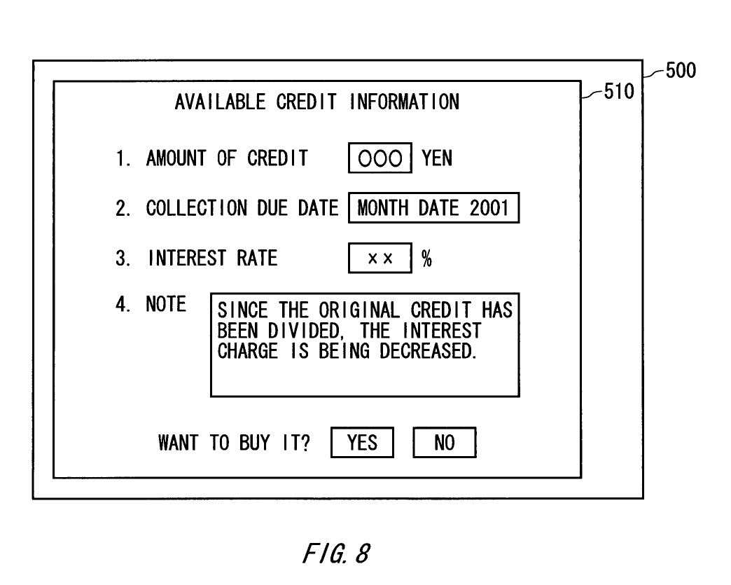

FIG. 8 shows another example of the display of the displaying unit 510 of the terminal for the user who desires to acquire an obligation 500. In the present example, the displaying unit 510 displays the information about the composed obligation sent by the confirming unit 310 of the supporting system for establishing an obligation 200. More particularly, the displaying unit 510 displays the amount of the composed obligation, the collection due date, the interest rate, “Yes” and ”no” buttons, which are the user who desires to acquire a credit clicks on in case of accepting the acquisition of the credit and other information. The other information may indicate the interest charge, which the user who desires to acquire a credit should receive, is decreased, because the present credit has been divided.

The display of the information about the composed obligation sent by the confirming unit 310 of the supporting system for establishing an obligation 200 will not be described, because it is substantially similar to the example above.

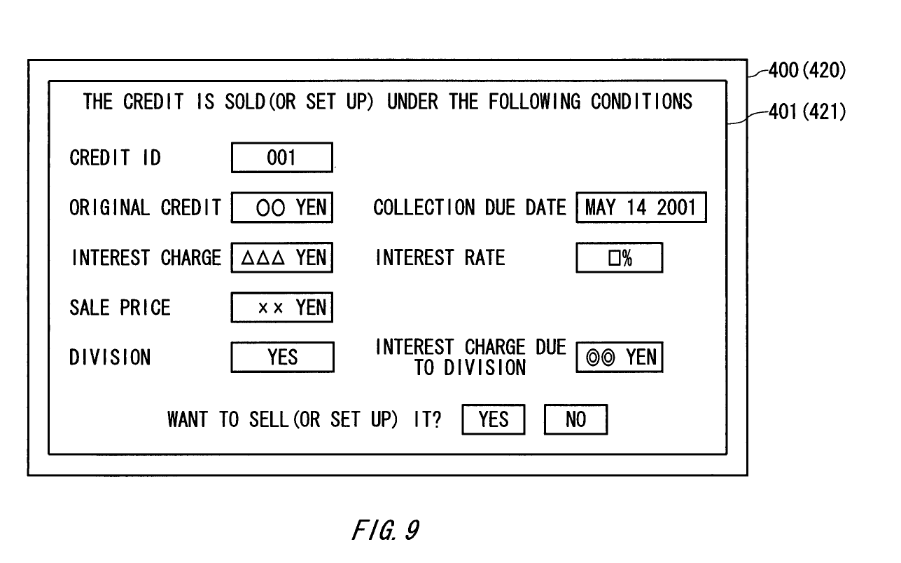

FIG. 9 shows an example of the displaying unit 401 or the displaying unit 421 of the obligor terminal 400 or the present obligee terminal 420. In the present example, the displaying unit 401 or the displaying unit 421 displays various information indicating the selling condition of the present obligation of the composed obligation including the figure of the receipt, namely, the sale price sent by the confirming unit 310 of the supporting system for establishing an obligation 200. More particularly, the displaying unit 401 or the displaying unit 421 displays the credit ID of the credit, which is the basis of the composed obligation, the price of the original obligation, the collection due date, the interest charge, the interestrate, the sale price, the division, the interest charge due to the division and the “yes” and “no” buttons by which the obligor or the present obligee confirms the set-up or the selling of the obligation.

The display of various information indicating the selling condition of the original debt of the composed debt including the amount of receipt, namely, the sale price sent by the confirming unit 310 of the supporting system for establishing an obligation 200 will not be described, because it is substantially similar to the example above.

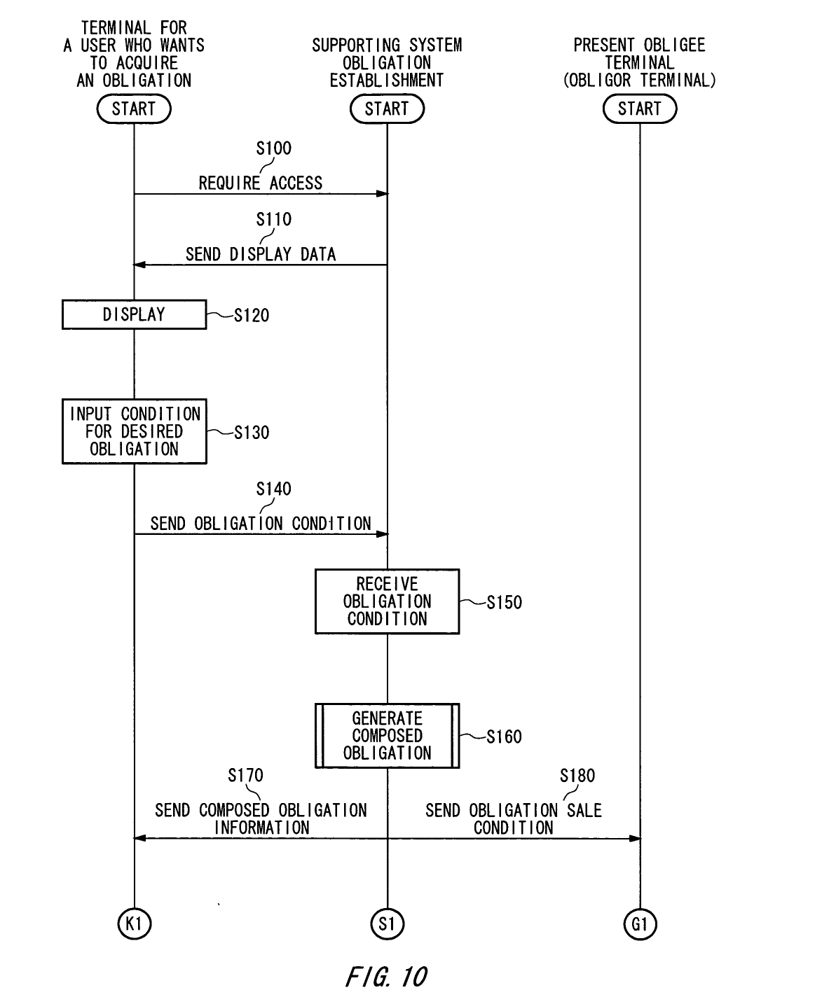

FIG. 10 shows a flowchart indicating the process of the supporting system for establishing an obligation 200, the obligor terminal 400 and the terminal for the user who desires to acquire an obligation 500. The present drawing is a flowchart when the composed obligation is generated.

First, the terminal for the user who desires to acquire an obligation 500 requires the access to the supporting system for establishing an obligation 200 (S100). When the supporting system for establishing an obligation 200 receives the access request of the terminal for the user who desires to acquire an obligation 500, it sends the input screen data to the terminal for the user who desires to acquire an obligation 500 (S110). When the terminal for the user who desires to acquire an obligation 500 receives the input screen data, it displays the input screen whose example is shown in FIG. 7 (S120). Then, the user who desires to acquire an obligation such as a credit, for example, inputs the condition of the desired credit to the terminal for the user who desires to acquire an obligation 500 (S130). And then, the terminal for the user who desires to acquire an obligation 500 sends the inputted condition of the credit to the supporting system for establishing an obligation 200 (S140). The supporting system for establishing an obligation 200 receives the condition of the composed obligation from the terminal for the user who desires to acquire an obligation 500 (S150), and it generates the composed obligation according to the condition (S160). Then, the supporting system for establishing an obligation 200 sends the information about the composed obligation to the terminal for the user who desires to acquire an obligation 500 (S170), and it sends the selling condition of the original obligation to the present obligee terminal 420 or the obligor terminal 400 (S180).

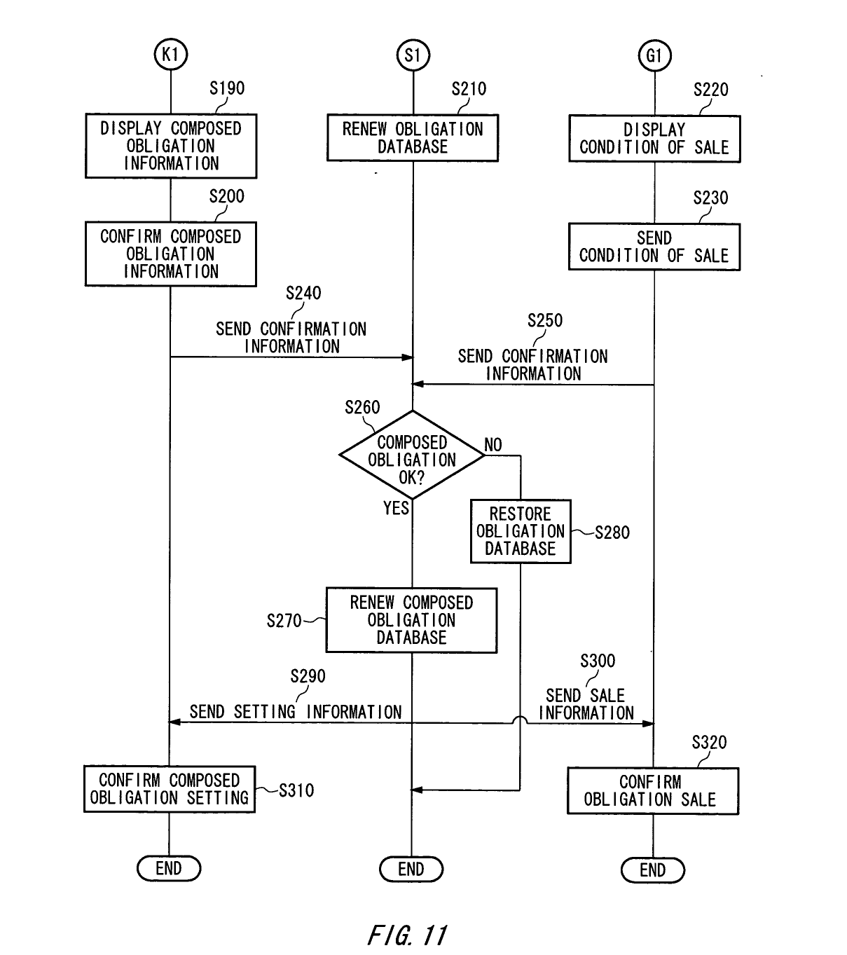

Then, the process goes on in FIG. 11. When the terminal for the user who desires to acquire an obligation 500 receives the information about the composed obligation, it displays the information about the composed obligation like the example shown in FIG. 8 (S190). And then, if the user who desires to acquire a credit confirms the information about the composed obligation, for example, by clicking on the “yes” or “no” button on the screen 510 (S200), the terminal for the user who desires to acquire an obligation 500 sends the information indicating that the user who desires to acquire a credit has confirmed the information about the composed obligation (S240).

Meanwhile, the supporting system for establishing an obligation 200 renews the obligation database 210 and stores the information indicating that the obligation is the object of the sale as the original obligation (S210).

Moreover, the present obligee terminal 420 or the obligor terminal 400 displays the received selling information of the credit as shown in FIG. 9 (S220) so that the present obligee or the obligor may confirm the selling condition of the credit, for example, by clicking on the “yes” or “no” button. Then, if the present obligee confirms the selling condition, the present obligee terminal 420 or the obligor terminal 400 sends the information indicating the confirmation to the supporting system for establishing an obligation 200 (S250).

And then, the supporting system for establishing an obligation 200 confirms the information sent by the terminal for the user who desires to acquire an obligation 500 and the present obligee terminal 420 or the obligor terminal 400. If it is confirmed that the user who desires to acquire a credit understands the purchase of the composed obligation and the present obligee or the obligor understands the set-up and the sale of the credit from the information (S260), the supporting system for establishing an obligation 200 renews the composed obligation database 240 by storing the information about the composed obligation in the composed obligation database 240 (S270).

On the other hand, if any of the user who desires to acquire a credit and the present obligee or the obligor does not understand the condition of the composed obligation or the selling/set-up condition of the original obligation, the supporting system for establishing an obligation 200 judges that the composed obligation can not be sold (S260), renews the obligation database 210 and stops the process by deleting the information indicating that the credit is the object of the sale (S280).

In step S290, the supporting system for establishing an obligation 200 sends the information indicating that it is confirmed that the composed obligation is set to be sold to the terminal for the user who desires to acquire an obligation 500. And then, the supporting system for establishing an obligation 200 the information indicating that it is confirmed that the original obligation is set to be sold to the present obligee terminal 420 or the obligor terminal 400 (S300).

If the terminal for the user who desires to acquire an obligation 500 receives the information indicating that it is confirmed that the composed obligation is set to be sold from the supporting system for establishing an obligation 200, it finishes the process, after allowing the user who desires to acquire a credit to confirm the information by displaying the information (S310).

Meanwhile, if the present obligee terminal 420 or the obligor terminal 400 receives the information indicating that it is confirmed that the original obligation is set to be sold from the supporting system for establishing an obligation 200, it finishes the process, after the present obligee to confirm the information by displaying the information (S320).

Therefore, by using the supporting system for establishing an obligation 200, it is possible to provide the obligation according to the desire of the user who desires to acquire a credit.

Moreover, it is possible to sell the obligation, which has the high collection risk so that it cannot be sold individually, as a part of the composed obligation resulting from the combination of the credits or the debts having the low collection risk.

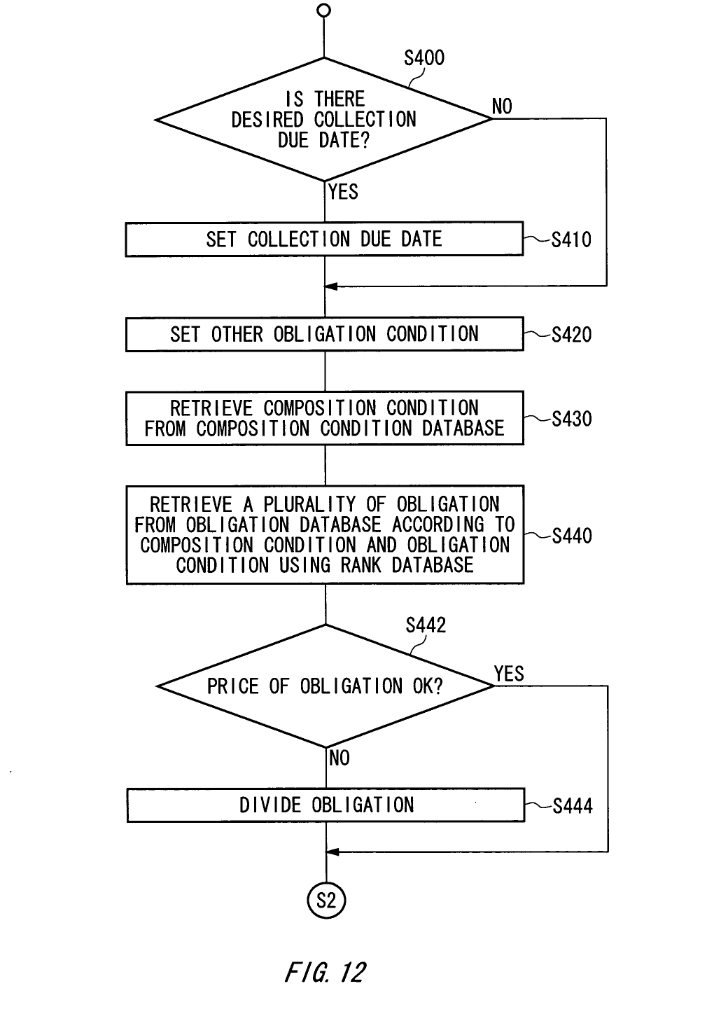

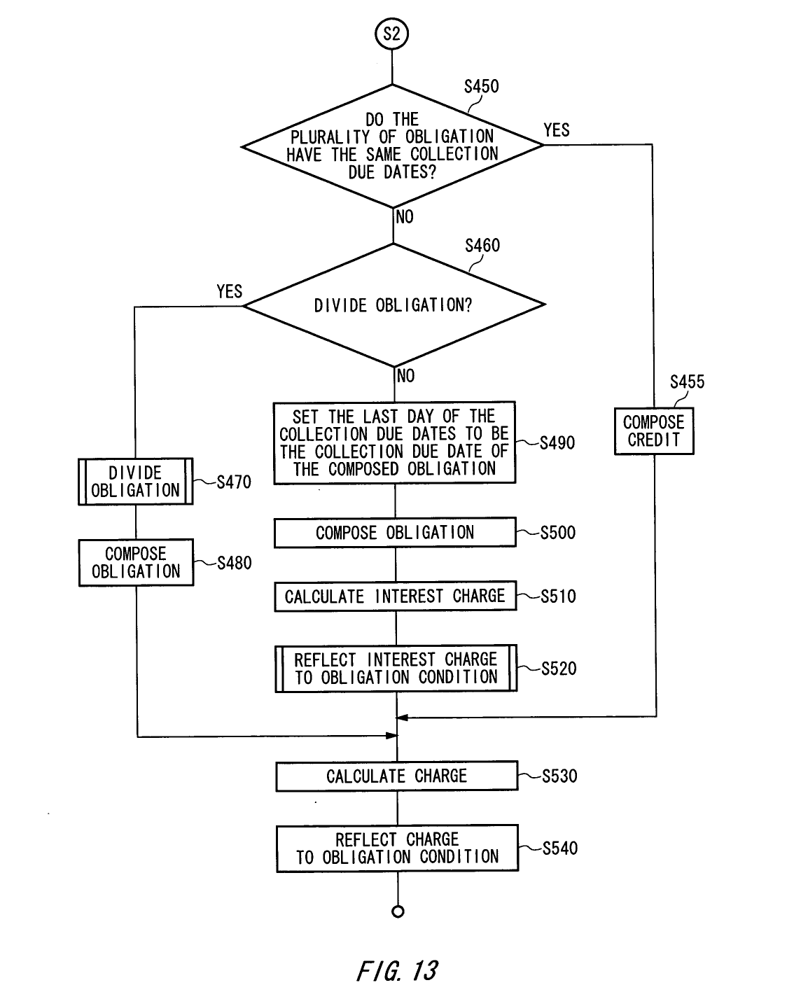

FIG. 12 and FIG. 13 are the flowcharts showing the detailed process of the step S160 shown in FIG. 10.

The obligation composing unit 270 of the supporting system for establishing an obligation 200 confirms whether or not the collection due date, which the user who desires to acquire a credit desires, exists in the condition sent by the terminal for the user who desires to acquire an obligation 500 (S400). If the collection due date desired exists, the obligation composing unit 270 set the day to be the collection due date of the composed obligation (S410). If the collection due date desired does not exist (S400), the obligation composing unit 270 goes to the step S420.

Then, the obligation composing unit 270 sets the condition for other composed obligation based on the information sent by the terminal for the user who desires to acquire an obligation 500 (S420). And, the obligation composing unit 270 retrieves the composed condition from the composition condition database 240 based on the rank of the collection risk of the composed obligation included in the condition, which is set (S430). Then, the obligation composing unit 270 sends the composition condition and the credit condition, which are set, to the obligation information obtaining unit 280. When the obligation information obtaining unit 280 receives the composition condition and the credit condition, it retrieves the credits matching the conditions from the obligation database 210 by using the rank database 220 (S440) And, the obligation information obtaining unit 280 sends the retrieved information about the credit to the obligation composing unit 270.

Then, the obligation composing unit 270 confirms whether or not the combination of the obligations fits the price of the obligation obtained by the requirement obtaining unit 260 (S442). If it does not fit, the obligation composing unit 270 divides the obligation by using the obligation dividing unit 275 (S444).

In FIG. 13, the obligation composing unit 270 confirms whether or not the collection due dates of the credits are the same (S450). If the collection due dates are the same, the obligation composing unit 270 composes the credit, for example, simply by adding the credits (S455) and goes to the step S530.

If the collection due dates are different, the obligation composing unit 270 judges whether or not the credit should be divided (S460). For example, if the obligation composing unit 270 judges that it is necessary to divide the credit such that the collection due date of the composed obligation is earlier than at least one of the collection due dates of the original obligations, it divides the credit by using the obligation dividing unit 275, sets the collection due date to be the collection due date of the composed obligation (S470) and composes the credit by using the divided credits (S480). The method of composing the credit here is the same as, for example, that in the step S455.

Meanwhile, if the obligation composing unit 270 judges that it is not necessary to divide the obligation such that the collection due date of the composed obligation is later than all of the collection due dates of the original obligations in the step S460, it composes the credit by setting the last collection due date of the credits to be the collection due date of the composed obligation (S490 and S500) and sends the information of the composed obligation and the interest charge to the payment setting unit 290 or the receiving amount setting unit 300. Then, the payment setting unit 290 or the receiving amount setting unit 300 calculates the interest charge created from the collection due date of the credit to the collection due date of the composed obligation (S500) and reflects the interest charge in the credit condition (S520).

Then, the payment setting unit 290 and the receiving amount setting unit 300 calculate the charge (S530) and reflects the charge in the credit condition (S540). Then, the supporting system for establishing an obligation 200 finishes the process of generating the composed obligation.

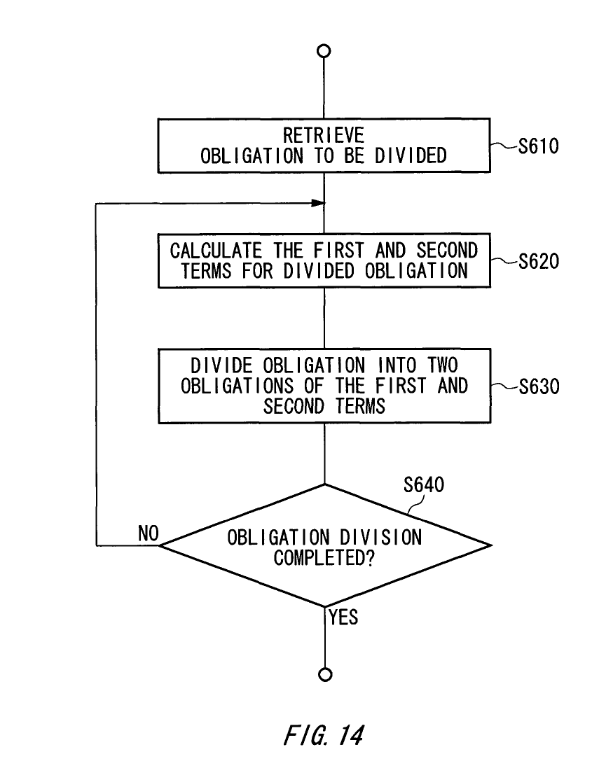

FIG. 14 is the flowchart showing the detailed process of the step S470 shown in FIG. 13.

The obligation composing unit 270 retrieves the credit to be divided (S610). Then, the obligation dividing unit 275 calculates the first and second terms of the credit by recognizing the collection due date of the composed obligation and the collection due date of the credit (S620) and divides the credit into the credits of the first and second terms (S630). Here, the first term is a term from the credit setting date of the original obligation to the collection due date of the composed obligation, and the second term is a term from the collection due date of the composed obligation to the collection due date of the original obligation. Then, if the division is completed for all of the credits to be divided, the process ends (S640). Otherwise, the process returns to the step S620.

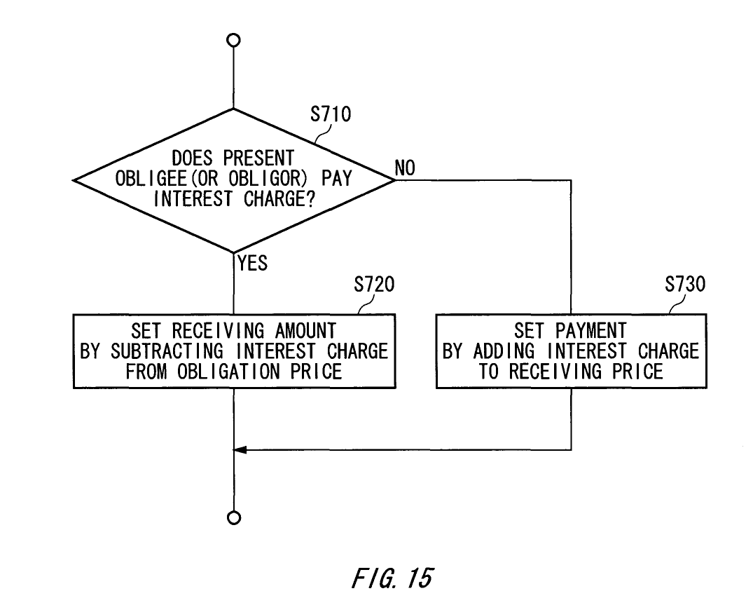

FIG. 15 is the flowchart showing the detailed process of the step S520 shown in FIG. 13. The obligation composing unit 270 judges whether or not the present obligee or the obligor pays the interest charge (S710). If the present obligee or the obligor pays it, the obligation composing unit 270 sends the predetermined information to the receiving amount setting unit 300. Then, the receiving amount setting unit 300 sets the amount of the receipt to which the interest charge is reflected (S720). If the present obligee or the obligor does not pay the interest charge, the obligation composing unit 270 sends the predetermined information to the payment setting unit 290. The payment setting unit 290 sets the amount of the payment by reflecting the interest charge to the amount of the receipt (S730). The process of the supporting system for establishing an obligation 200, the obligor terminal 400 and the terminal for the user who desires to acquire an obligation 500 during generating the composed debt will not be described, because it is substantially similar to the process of generating the composed debt described with regard to FIG. 10 to FIG. 15.

Therefore, according to the supporting system for establishing an obligation 200, though the collection due date of the composed obligation does not the same as the collection due dates of all the original obligations, it is possible to generate the composed obligation. Hence, the range of establishing the composed obligation, namely, the possibility that the original obligation is set and sold is increased.

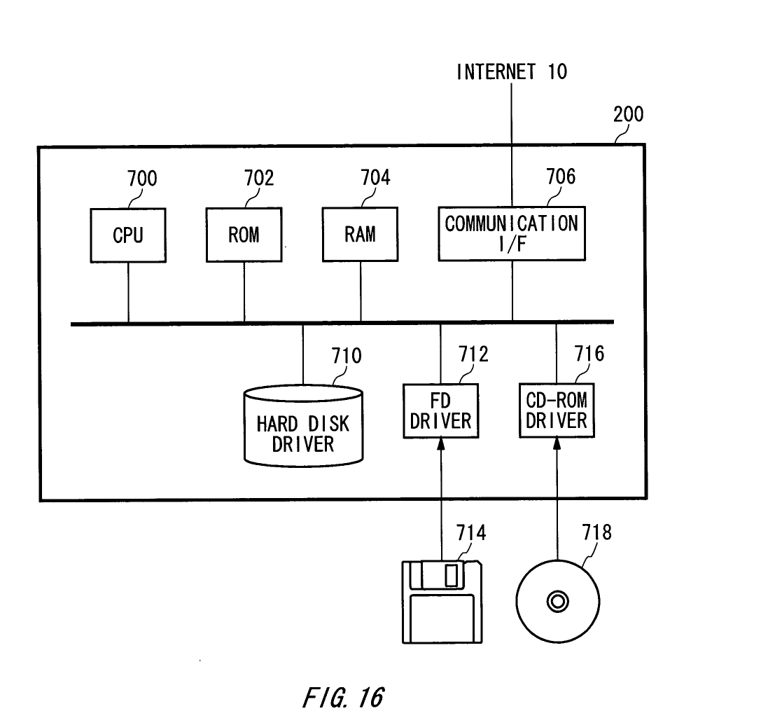

FIG. 16 is the block diagram showing the hardware configuration of the supporting system for establishing an obligation 200. The supporting system for establishing an obligation 200 includes a CPU 700, a ROM 702, a RAM 704 and a communication interface 706. The CPU 700 operates based on the program stored in the ROM 702 and the RAM 704. The communication interface 706 communicates with the exterior through the Internet 10. A hard disk driver 710 is an example of the memory, and it stores the setting information and the program, which drives the CPU 700.

A floppy-disk driver 712 reads the data or the program from a floppy disk 714 and provides it to the CPU 700. A CD-ROM driver 716 reads the data or the program from a CD-ROM 718 and provides it to the CPU 700. The communication interface 706 receives and sends the data through the Internet 10.

The software executed by the CPU 700 is provided to the user being stored in the floppy disk 714 or the CD-ROM 718. The software stored in the recording medium may be compressed or not. The software is installed in the hard disk driver 710 and executed by the CPU 700 being stored in the RAM 704.

The software provided being stored in the recording medium, namely, the software installed in hard disk driver 710 includes an obligation receiving module, a requirement obtaining module, an obligation composing module, an obligation information obtaining module, a payment setting module, a receiving amount setting unit, a confirming module and a confirmation receiving module.

The process, which these modules allows the CPU 700 to perform, with respect to the supporting system for establishing an obligation 200 according to the present embodiments will not be described, because it is similar to the function and the process of the corresponding units.

The floppy disk 714 or the CD-ROM 718 shown in FIG. 16 can stores a part or all of the process or the function of the supporting system for establishing an obligation 200 with respect to every embodiment described in the present application.

The program may be read from the recording medium and stored in the RAM or it may be installed in the hard disk driver and executed being stored in the RAM. Furthermore, the program may be stored in one recording medium or may be stored in a plurality of media. Moreover, the modules stored in the recording medium may be functioning along with the operating system. For example, the modules may request the operating system to perform the part or all of the function of them and be functioning based on the response from the operating system.

As the recording medium in addition to the floppy disk and the CD-ROM, the optical recording medium such as DVD, the magnetic recording medium such as MD, the magnetic and optical recording medium such as PD, the tape medium, the magnetic recording medium, the semiconductor memory such as the IC card or the miniature card can be used. Moreover, the program can be provided to the supporting system for establishing an obligation 200 through the communication network by using the memory such as the hard disk or the RAM installed in the server system coupled to the leased line or the Internet as the recording medium.

Since the recording medium is used in order to manufacture the supporting system for establishing an obligation 200, it is evident that manufacturing or selling the recording medium for the business purpose infringes the patent based on the present application.

### 2. SECOND EMBODIMENT

The supporting system for establishing an obligation 201 as the second example of the present embodiment, like the supporting system for establishing an obligation 200 as the first example, is coupled to the obligor terminal 400, the present obligee terminal 420 and the terminal for the user who desires to acquire an obligation 500 through the Internet 10. The present obligee and the user who desires to acquire a credit may include several, different kinds of investors. The users maybe in various segment concerning financial institutions. The supporting system for establishing an obligation 200 gets the request of the obligor for establishing a credit such as a credit sale or a debt such as an acceptance of the debt from the obligor terminal 400 or the request of the present obligee for selling a credit or debt from the present obligee terminal 420. Moreover, the supporting system for establishing an obligation 200 obtains the condition of the obligation, which the user who desires to acquire a credit desires, from the terminal for a user who desires to acquire an obligation 500, chooses the credits or the debt according to the obtained condition of the obligation and sends the chosen condition of the obligation to the terminal for the user who desires to acquire an obligation 500.

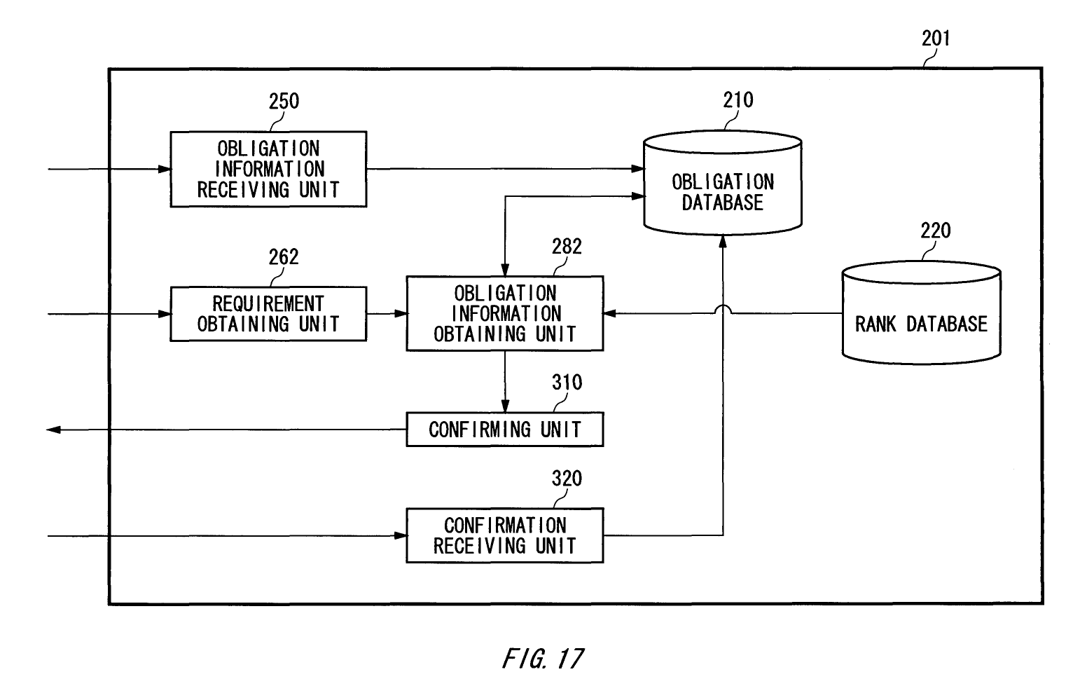

FIG. 17 shows an example of the supporting system for establishing an obligation 201. In the present embodiment, the supporting system for establishing an obligation 201 has an obligation database 210 and a rank database 220 as databases and has an obligation information receiving unit 250, a requirement obtaining unit 262, an obligation information obtaining unit 282, a confirming unit 310 and a confirmation receiving unit 320 as operating units. The function and the configuration of the obligation database 210, the rank database 220 and the obligation information receiving unit 250 will not be described in detailed, they are substantially similar to those of the supporting system for establishing an obligation 200.

The requirement obtaining unit 262 obtains the condition of the obligation, which the user who desires to acquire a credit desires to buy or set, from the terminal for the user who desires to acquire an obligation 500, and it sends the condition to the obligation information obtaining unit 282. Here, the information received by the requirement obtaining unit 262 includes the information by which whether the request is the obligation is discriminated.

The obligation information obtaining unit 282 chooses the obligation matching the condition sent by the requirement obtaining unit 262 in the obligation database 210 and sends the information about the chosen credit or debt to the confirming unit 310. At this time, the obligation information obtaining unit 282 obtains the collection rank of the obligor stored in the obligation database 210 by using the rank database 220 and chooses the obligation in the obligation database 210 by using the obtained collection rank.

Moreover, the obligation information obtaining unit 282 stores the information indicating that the chosen credit or debt is the object of the sale or the set-up in the obligation database 210.

When the confirming unit 310 receives the information about the obligation and the customers, sets the amount of the payment of the obligation considering the charge and sends the information including the amount of the payment to the terminal for the user who desires to acquire an obligation 500, while sending the information about the composed obligation including the amount of the receipt to the obligor terminal 400 or the present obligee terminal 420.

The confirmation receiving unit 320 receives the information indicating the acceptance of selling the obligation from the obligor terminal 400 or the present obligee terminal 420 and the information indicating the acceptance of buying the composed obligation from the terminal for the user who desires to acquire an obligation 500. In the mean time, if the confirmation receiving unit 320 receives the information indicating the refusal to sell the obligation from the obligor terminal 400 or the present obligee terminal 420 and the information indicating the refusal to buy the composed obligation from the terminal for the user who desires to acquire an obligation 500, it deletes the information indicating that the chosen credit or debt is the object of the sale from the obligation database 210.

Therefore, according to the supporting system for establishing an obligation 201, it is possible to sell the credit or debt even between the several, different kinds of investors, for example. Hence, in contrast to the conventional method, it is possible to provide the obligation according to the desire of the user who desires to acquire a credit. Moreover, it is possible to sell the obligation, which has the high collection risk so that it cannot be sold individually, as apart of the composed obligation resulting from the combination of the credits or the debts having the low collection risk.

Although the present invention has been described by way of exemplary embodiments, it should be understood that those skilled in the art might make many changes and substitutions without departing from the spirit and the scope of the present invention which is defined only by the appended claims.

1. A supporting system for establishing an obligation, comprising:
a requirement obtaining unit for obtaining a condition of an obligation desired by a user who desires to acquire an obligation;
an obligation information obtaining unit for obtaining a detailed condition including amount and a collection due date of said obligation; and
an obligation composing unit for generating a composed obligation according to said condition obtained by said requirement obtaining unit by combining a plurality of obligations based on said detailed condition obtained by said obligation information obtaining unit.

2. A supporting system for establishing an obligation as claimed in claim 1, further comprising a rank storing unit for storing a rank indicating a collection risk of said obligor,
wherein said obligation composing unit decides said obligation by using said rank stored in said rank storing unit.

3. A supporting system for establishing an obligation as claimed in claim 1, further comprising a composition condition database for storing a condition under which said plurality of obligations are composed,
wherein said obligation composing unit generates said composed obligation by using said condition stored in said composition condition database.

4. A supporting system for establishing an obligation as claimed in claim 1, wherein said requirement obtaining unit obtains a collection due date desired by said user who desires to acquire an obligation, and
said obligation composing unit sets said collection due date obtained by said requirement obtaining unit to be a collection due date of said composed obligation.

5. A supporting system for establishing an obligation as claimed in claim 4, further comprising an interest charge adding unit for calculating an interest charge created during a term from a collection due date of said obligation to said collection due date of said composed obligation, and adding said interest charge to money flow created by a transaction of said original obligation.

6. A supporting system for establishing an obligation as claimed in claim 1, wherein said obligation composing unit divides said obligation, of which collection due date is later than a collection due date of said composed obligation, into a plurality of obligations by dividing a payment term of said obligation, and generates said composed obligation by using said divided obligations.

7. A supporting system for establishing an obligation as claimed in claim 1, wherein said obligation composing unit divides said obligation into a plurality of obligations by dividing amount of said obligation and generates said composed obligation by using at least one of said divided obligations.

8. A supporting system for establishing an obligation, comprising:
an obligation database for storing a condition of an obligation to be an object of selling or setting;
a requirement obtaining unit for obtaining a condition of an obligation desired by users who desire to acquire an obligation from terminals for said users, wherein said users comprise several, different kinds of investors;
an obligation information obtaining unit for obtaining information about said obligation according to said condition obtained by said requirement obtaining unit from said obligation database; and
a confirming unit for allowing said users to confirm said information obtained by said obligation information obtaining unit by sending said information to said terminals for said users.

9. A supporting method for establishing an obligation, comprising the steps of:
obtaining a condition of an obligation desired by a user who desires to acquire an obligation;
obtaining a detailed condition including amount and collection due dates of said obligations;
generating a composed obligation according to said obtained condition by combining said obligations based on said detailed condition; and
informing said user of said condition of said composed obligation.

10. A supporting method for establishing an obligation, comprising the steps of:
managing a condition an obligation to be an object of selling or setting;
obtaining a condition of said obligation desired by users who desire to acquire a credit, wherein said users comprise several, different kinds of investors and selecting an obligation according to said obtained condition from said managed obligation; and
informing said users of said selected obligation.

11. A supporting computer program for establishing an obligation, comprising:
a requirement obtaining module for obtaining a condition of an obligation desired by a user who desires to acquire an obligation;
a credit condition obtaining module for obtaining a detailed condition including amount and collection due dates of said obligations; and
a credit composing module for generating a composed obligation according to said condition obtained by said requirement obtaining module by combining a plurality of said obligations based on collection risk and said price of obligation.

12. A supporting computer program for establishing an obligation, comprising:
a requirement obtaining module for obtaining a condition of an obligation desired by users who desire to acquire an obligation from terminals for said users, wherein said users include several, different kinds of investors;
an obligation information obtaining module for obtaining information about said obligation according to said condition obtained by said requirement obtaining module from an obligation database storing a condition of said obligation to be an object of selling or setting; and
a confirming module for allowing said users to confirm said information obtained by said obligation information obtaining module by sending said information to said terminals for said users.
